(19) United States
(12) Patent Application Publication
(10) Pub. No.: US 2009/0186590 A1
(43) Pub. Date: Jul. 23, 2009

(54) Method for Channel Calibration

(75) Inventor: Simon Gale, Hertfordshire (GB)

Correspondence Address: BARNES & THORNBURG LLP, P.O. BOX 2786, CHICAGO, IL, 60690-2786, US

(73) Assignee: NORTEL NETOWRKS LIMITED, St. Laurent (CA)

(21) Appl. No.: 12/016,712

(22) Filed: Jan. 18, 2008

(51) Int. Cl. H04B 1/06

(52) U.S. Cl. 455/272

(57) ABSTRACT

The present invention provides an improved method for calibrating transmitter and receiver circuits in a device having multiple antennas. The method involves transmitting pilot signals from the device to a second device and from the second device to the device. Each device determines the relative differences between the signals received by a first antenna and by each of the other antennas. The relative differences can then be used to calculate calibration factors that can be applied to the transmitter and receiver circuits.

### FIELD OF THE INVENTION

This invention relates to a method of calibrating a device having multiple antennas. The invention is applicable to use within base stations of a cellular telecommunications network.

### BACKGROUND OF THE INVENTION

In communications systems, such as a cellular communication system, it is advantageous to use multiple transmitters and receivers to exchange data wirelessly between two terminals. The use of multiple transmitters and receivers results in an improved performance with, for example, increased transmission range, an improved signal to noise ratio, interference rejection for received signals and a reduced power requirement for transmitted signals.

In a known multiple antenna arrangement, such as that illustrated in FIG. 1 and used in a cellular communication system, a base station 10 is provided with multiple antennas 12-1, 12-2, 12-n, arranged to both transmit and receive data to mobile terminals such as a cellular telephone 14. When the base station 10 transmits a signal to the mobile station 14 using the multiple antennas 12 each transmission by each signal will take a different path 16-1, 16-2, 16-n to the antenna at the mobile station 14.

In order to maximise the signal level at the mobile terminals' antenna, or to obtain optimum MIMO performance with a multi-antenna terminal, it is advantageous to calibrate the phase and amplitude of the signals transmitted and received by the base station 10 so that advantage may be taken from channel knowledge gained from the uplink.

Traditionally, in order to achieve this hardware, such as directional couplers and a calibration transceiver, is introduced into the base station. This results in extra expense when building networks and also additional complexity in the terminals. Furthermore, if tower top amplifiers or other non-reciprocal tower top equipment are employed then further expense and complexity will be encountered as tower top calibration couplers and associated feeders will also be required.

Hence, what is needed is a more efficient way for calibrating a terminal having multiple antennas.

### SUMMARY OF THE INVENTION

According to a first aspect of the invention there is provided a method of calibrating a first terminal including a plurality of antennas comprising the steps of transmitting pilot signals from each of the plurality of antennas to an antenna on a second terminal, the second terminal, upon receiving the pilot signals, calculating a transmitter value for each antenna, the transmitter value representing the relative value of the pilot signals received from that antenna to the received pilot signals of a selected antenna, the second terminal transmitting pilot signals to the first terminal, the first wireless terminal, upon receiving the pilot signals, calculating a receiver value for each antenna, the receiver value representing a relative value of the pilot signals received by that antenna to the pilot signals received by a selected antenna, the second terminal transmitting the transmitter values for each antenna to the first terminal and the first terminal calculating correction factors for each of the antennas.

By calculating correction factors in this way the need for extra hardware to perform calibration is negated.

The first terminal may include n antennas where n is an integer value; the transmitter value being the ratio of pilot signals received from an antenna between 1 and n to the pilot signals received from a first antenna.

The ratio may be calculated using the following equation:

$${M}_{n} = \frac{{α}_{n , T} * {H}_{n}}{{α}_{1 , T} * {H}_{1}}$$

where Mₙ is the transmitter value for antenna n
   α_{n,T} is the complex factor introduced by the transmission circuit
   Hₙ is the complex factor introduced by the radio propagation channel and
   n indicates which antenna transmitted the pilot signals.

Correspondingly, the receiver value may be the ratio of pilot signals received on an antenna between 1 and n to the pilot signals received on a first antenna.

The ratio may be calculated using the following equation:

$${B}_{n} = \frac{{α}_{n , R} * {H}_{n}}{{α}_{1 , R} * {H}_{1}}$$

where Bₙ is the receiver value for antenna n,
   α_{n,R} is the complex factor introduced by the receiver circuit,
   Hₙ is the complex factor introduced by the radio propagation channel and
   n indicates which antenna received the pilot signals.

The correction factors may be calculated for each of the antennas by comparing the transmitter value and the receiver value. This comparison may be performed for the phase correction factor using the following equation (in this case, assuming that the phase correction is added to the transmit signal path, excepting the time period during the calibration measurement):

$$C {ϕ}_{n} = arg ( \frac{{B}_{n}}{{M}_{n}} )$$

where Cφₙ is the phase correction factor for antenna n,
Bₙ is receiver complex value for antenna n,
Mₙ is the complex transmitter value for antenna n.

In addition, the comparison may be performed for the amplitude correction factor using the following equation (in this case, it is assumed that the amplitude correction factor is applied to the receive path, excepting to pilots used for the purpose of the calibration measurement):

$${CA}_{n} = abs ( \frac{{M}_{n}}{{B}_{n}} )$$

where CAₙ is the amplitude correction factor for antenna n,
Bₙ is receiver complex value for antenna n,
Mₙ is the complex transmitter value for antenna n.

As the various parameters are in general dependent on frequency, the pilot signals may be transmitted over a number of pilot frequencies to permit frequency specific corrections to be made. This also allows calibration correction factors for frequencies between the pilot frequencies to be calculated by interpolation.

The first terminal may be a base station and the second terminal may be a mobile terminal. In this instance, the mobile terminal velocity may be determined to see if it is below a threshold value in order to prevent use of a high velocity mobile terminal which will introduce errors into the calibration factors. The velocity may be determined by the base station using the Doppler spectrum for signals received from the mobile terminal.

The second terminal may also have a plurality of antennas and be arranged to transmit and receive pilot signals in an analogous manner to the first terminal in order that it can calculate correction factors for each of its plurality of antennas using the same method as the first terminal. The second terminal may exchange pilot signals with the first terminal or a separate terminal.

Advantageously, the first and second transmitters are arranged to transmit signals using time division duplex.

In accordance with a second aspect of the present invention there is provided a terminal comprising a plurality of antennas arranged to transmit pilot signals to a second terminal, receive pilot signals from the second terminal and receive a transmitter value from the second terminal; processing means arranged to calculating a receiver value for each antenna, the receiver value representing a relative value of the pilot signals received by that antenna to the pilot signals received by a selected antenna, and calculating correction factors for each of the antennas. The terminal may be a base station in a cellular communication system.

In accordance with a second aspect of the present invention there is provided a terminal comprising an antenna configured to receive pilot signals from each of a plurality of antennas on a second terminal; transmit pilot signals to a second terminal, transmit the transmitter value for each antenna to the second terminal, and processing means arranged to, upon receiving the pilot signals, calculate a transmitter value for each antenna, the transmitter value representing the relative value of the pilot signals received from that antenna to the received pilot signals of a selected antenna. The terminal may be a mobile terminal in a cellular communication system.

### BRIEF DESCRIPTION OF THE DRAWINGS

Other aspects and features of the present invention will become apparent to those ordinarily skilled in the art upon review of the following description of specific embodiments of the invention in conjunction with the accompanying figures.

FIG. 1 illustrates a prior art cellular communications system;

FIG. 2 illustrates a communications system in accordance with the present invention.

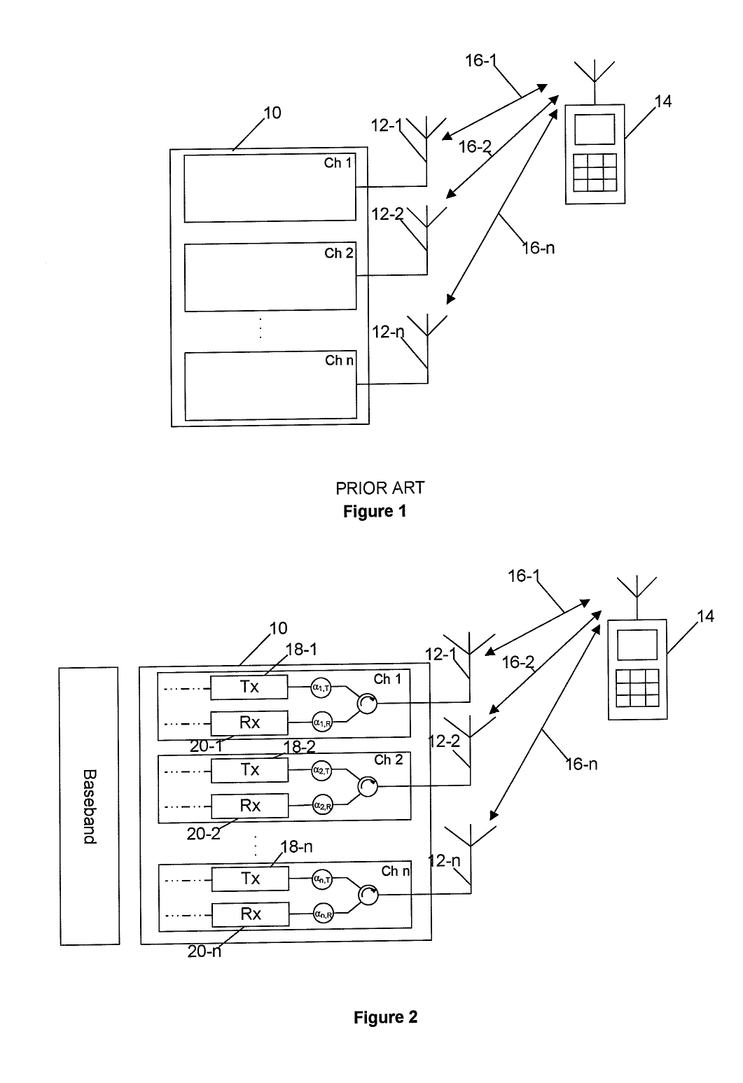

### DETAILED DESCRIPTION OF PREFERRED EMBODIMENTS

The present invention will be discussed with reference to a cellular communications system including base stations and mobile terminals. However, it may be implemented between any two terminals that are connected by wireless communication channels.

FIG. 2 illustrates the apparatus of the present invention. As in conventional wireless cellular communications systems there is a base station 10 having n antennas 12-1, 12-2 . . . 12-n. Each antenna 12-1, 12-2 . . . 12-n is connected to a transmission circuit 18-1, 18-2 . . . 18-n and a receiver circuit 20-1, 20-2 . . . 20-n.

The transmission circuit is responsible for processing the signals prior to them being transmitted by the antenna and the receiver circuit is responsible for processing the signals that are received by the antenna. Each circuit introduces particular complex frequency dependent factors that vary according to the circuit and radio channel being used. The introduced factors are denoted in FIG. 2 as α_{C,X} where C is the channel, and X represents either T or R where T indicates that it is introduced by the transmission circuit and R indicates that it is introduced by the receiver circuit.

To calibrate the system each antenna 12-1, 12-2 . . . 12-n at the base station 10 transmits a set of pilot symbols to the mobile terminal 14. Each set of pilot signals being processed by the transmission circuit associated with the antenna. The mobile terminal 14 receives the signal and calculates a series of channel measurements where all the antennas 12-1, 12-2 . . . 12-n are provided with a number in relation to a selected antenna in the base station 10.

For example, the mobile terminal 14 may calculate the ratio of the received signal transmitted by each antenna 12-1, 12-2 . . . 12-n with reference to the first antenna 12-1.

Thus the relative measurement obtained by the mobile terminal 14 for the second antenna 12-2 will be:

$${M}_{2} = \frac{{α}_{2 , T} * {H}_{2}}{{α}_{1 , T} * {H}_{1}}$$

and the relative measurement obtained for the nth antenna 12-1 will be:

$${M}_{n} = \frac{{α}_{n , T} * {H}_{n}}{{α}_{1 , T} * {H}_{1}}$$

The results of these calculations are then transmitted to the base station.

The mobile terminal 14 also transmits pilot symbols to the base station 10. The pilot symbols are received by each antenna 12-1, 12-2 . . . 12-n at the base station 10 and is passed through the appropriate receiver circuit 20-1, 20-2 . . . 20-n. Upon receiving the pilot signals the base station 10 also makes a series of channel measurement calculations for each antenna 12-1, 12-2 . . . 12-n. The measurements being calculated relative to the pilot symbols received by selected antenna, in this instance the first antenna 12-1, on the base station 10.

For example, the base station 10 may calculate the ratio of the signal received by each antenna 12-1, 12-2 . . . 12-n with reference to the first antenna 12-1. Thus the relative measurement obtained by the base station 10 for the second antenna 12-2 will be:

$${B}_{2} = \frac{{α}_{2 , R} * {H}_{2}}{{α}_{1 , R} * {H}_{1}}$$

and the relative measurement obtained for the nth antenna 12-n will be:

$${B}_{n} = \frac{{α}_{n , R} * {H}_{n}}{{α}_{1 , R} * {H}_{1}}$$

Preferably, the channel measurements are made over a number of pilot frequencies in the bandwidth used by the transmitters. This enables calibration to occur accurately at multiple frequencies.

Once the base station has calculated the relative values it can then calculate a phase correction to be applied to either the receiver or transmitter circuits. The phase corrections may be defined by the following equation (in this case, assuming that the phase correction is added to the transmit signal path, excepting the time period during the calibration measurement):

$$C {ϕ}_{n} = arg ( \frac{{B}_{n}}{{M}_{n}} ) for n > 1$$

as, in this example, all measurements are made relative to antenna 1 when n=1 Cφₙ=0 as the ratios calculated using the equations for measurements above will always be 1.

As will be understood by one skilled in the art, care has to be taken at the 0/2π boundary in order to correctly identify the discontinuities.

The correction factors can be applied for the pilot frequencies at which the pilot symbols were transmitted. Interpolation may be used to determine the correction factors that are to be applied when transmitting/receiving at frequencies between the pilot frequencies.

The present method may also be used to provide amplitude correction. When a signal is to be transmitted it is passed through a power amplifier (which may be linearized, requiring accurate power control or have its power controlled by other means). This means that the amplitude of a transmitted signal is tightly calibrated and it can be assumed that the transmission amplitudes for each transmitter are approximately equal.

However, calibration of the receiver circuitry may still be required. This may be achieved by calculating amplitude correction scaling factors. The amplitude correction scaling factors may be calculated using the following equations (in this case it is assumed that the amplitude correction factor is applied to the receive path, excepting to pilots used for the purpose of the calibration measurement):

$${CA}_{n} = abs ( \frac{{M}_{n}}{{B}_{n}} ) for n > 1$$

As discussed with reference to phase when n=1 the correction scaling factor is always 1 because the ratio is calculated with reference to antenna 1.

Although the invention has been described with the mobile terminal calculating the ratio of the received signal transmitted by each antenna with reference to signal transmitted by the first antenna, the skilled person will recognise that, other information may be sent to the base station.

For example, the mobile station may be configured to transmit data representing the amplitude or phase of the received signal for each transmitter to the base station. The base station can then calculate the relative values using the received data and above equations or any other suitable method. Alternatively, the mobile station may transmit a coded representation of values representing the signals received by the mobile station.

Additionally, the mobile terminal and base station may be adapted to use pilot signals that have been transmitted including a correction factor for the calibration measurement. This is advantageous as there would be no requirement to distinguish between pilot signals to be used for the calibration measurement and pilot signals to be used in normal use.

Optionally, in addition to compensating for amplitude and phase factors compensation the present invention may also be used to incorporate delay compensation, for example if one base station antenna cable was longer than another antenna cable. To compensate for delay the phase and amplitude information for different frequencies may be used to determine a delay difference and be used to adjust the transmission of data from each of the antennas accordingly.

Although any mobile terminal may be used to calculate the correction factors and thereby calibrate the base station transmitter and receiver circuits it is preferable that a slow moving or static mobile terminal is selected in order that the correction factors calculated are not affected by the change in channel state caused by the movement of the terminal.

The base station may be configured to determine the amount of movement using the spread in Doppler spectrum received from the mobile terminal to determine the velocity of a mobile terminal and, if the spread in Doppler spectrum is below a certain value it is suitable to use for calibration.

Preferably, the mobile terminal has a high Carrier to Interference-plus-Noise Ratio. This means that the effect of factors external to the channel are minimised in the channel measurements.

If desired the calibration may occur using channel measurements from multiple separate mobile terminals. The correction factors obtained from each of the mobile terminals being averaged and then applied to the circuitry. This increases the accuracy of the calibration and reduces the effect of erroneous measurements on the base station.

Advantageously the mobile terminal measurement timing is selected to produce a channel branch ratio that is close to unity (i.e. the magnitudes of all Hₙ values are approximately equal). This further minimises the effect of changing channel conditions on the ratios calculated.

The correction factors may be calculated repeatedly in order to mitigate for changes in the circuits that affect the transmission reception of signals. The period of time between calculation of correction factors may be predetermined, for example a timer may cause calibration signals to be transmitted after a predetermined amount of time has elapsed. Calibration errors tend to change relatively slowly and therefore the period of time may be relatively long, for example 10 minutes or more.

The method may be applied to a MIMO system where both terminals are provided with multiple antennas having both transmitter and receiver circuits. In this instance both terminals calculate calibration factors according to the methods above and apply the calibration factors in the usual manner.

Preferably, the method is implemented in a system where the same channel is used to transmit and receive signals between the two terminals. This enables reciprocity of the signals and means that channel effects are cancelled out as they affect the base station and mobile station measurements equally. For example, the method may be implemented upon transmitters using time division duplex.

What is claimed is:

1. A method of calibrating a first device including a plurality of antennas comprising the steps of:
a. transmitting pilot signals from each of the plurality of antennas to an antenna on a second device;
b. the second device transmitting information relating to the amplitude and/or phase of the pilot signals received from each antenna on the first device;
c. calculating a second relative value of the amplitude and/or phase of the pilot signals received by the second device from each antenna on the first device to the pilot signals received by the second device from a selected antenna on the first device;
d. the second device transmitting pilot signals to the first device
e. calculating a first relative value of the amplitude and/or phase of the pilot signals received from the second device by each antenna on the first device relative to the pilot signals received from the second device by a selected antenna on the first device;
f. calculating correction factors for each of the antennas using the first and second relative values.

2. The method of claim 1 wherein the first device includes n antennas where n is an integer value and the second relative value is the ratio of pilot signals received from an antenna between 2 and n to the pilot signals received from a first antenna.

3. The method of claim 2 wherein the ratio is calculated using the following equation:
$${M}_{n} = \frac{{α}_{n , T} * {H}_{n}}{{α}_{1 , T} * {H}_{1}}$$
where Mₙ is the transmitter value for antenna n
α_{n,T} is the factor introduced by the transmission circuit and
n indicates which antenna transmitted the pilot signals.

4. The method of claim 1 wherein the first device includes n antennas where n is an integer value and the receiver value is the ratio of pilot signals received on an antenna between 1 and n to the pilot signals received on a first antenna.

5. The method of claim 4 wherein the ratio is calculated using the following equation:
$${B}_{n} = \frac{{α}_{n , R} * {H}_{n}}{{α}_{1 , R} * {H}_{1}}$$
where Bₙ is the complex receiver value for antenna n;
α_{n,R} is the complex factor introduced by the receiver circuit;
Hₙ is the complex factor introduced by the radio propagation channel and
n indicates which antenna received the pilot signals.

6. The method of claim 1 wherein the step of calculating correction factors for each of the antennas comprises the step of comparing the transmitter value and the receiver value.

7. The method of claim 6 wherein comparing the transmitter value and the receiver value comprises calculating
$$C {ϕ}_{n} = arg ( \frac{{B}_{n}}{{M}_{n}} )$$
where Cφₙ is the phase correction value to be added in the transmit path for antenna n,
Bₙ is receiver complex value for antenna n,
Mₙ is the transmitter complex value for antenna n.

8. The method of claim 6 wherein comparing the transmitter value and the receiver value comprises calculating
$${CA}_{n} = abs ( \frac{{M}_{n}}{{B}_{n}} )$$
where CAₙ is the amplitude correction scaling factor to be applied in the receive path for antenna n,
Bₙ is receiver complex value for antenna n,
Mₙ is the transmitter complex value for antenna n.

9. The method of claim 1 wherein the pilot signals are transmitted over a number of pilot frequencies.

10. The method of claim 9 wherein the calibration correction factor for frequencies between the pilot frequencies is calculated by interpolation.

11. The method of claim 1 wherein the first device is a base station and the second device is a mobile terminal.

12. The method of claim 11 further comprising the step of determining whether the mobile terminal has a velocity below a threshold value.

13. The method of claim 12 wherein the velocity is determined by the base station using the Doppler spectrum for signals received from the mobile terminal.

14. The method of claim 1 wherein the second device comprises a plurality of antennas and is arranged to calculate correction factors for each of the plurality of antennas using the method of claim 1.

15. The method of claim 1 wherein the first and second transmitters are arranged to transmit signals using time division duplex.

16. A device including a plurality of antennas, and processing means, the device being configured to:
a. transmit pilot signals from each of the plurality of antennas;
b. receive pilot signals at each of the plurality of antennas;
c. receive information relating to the amplitude and/or phase of the pilot signals transmitted from each antenna from a second device
d. calculate a first relative value of the amplitude and/or phase of the pilot signals received from the second device by each antenna compared to the pilot signals received from the second device by a selected antenna;
e. determine correction factors for each of the antennas using the received information relating to the amplitude and/or phase of the pilot signals and the first relative value.

17. The device of claim 16 wherein the information relating to the amplitude and/or phase of the pilot signals is data representing the amplitude and/or phase of the pilot signals received by the second device and the step of determining correction factors for each of the antennas includes the step of calculating a second relative value of the amplitude and/or phase of the pilot signals received by the second device from each of the plurality of antennas compared to the pilot signals received by the second device from a selected antenna.

18. The device of claim 16 wherein the information relating to the amplitude and/or phase of the pilot signals is a second relative value of the amplitude and/or phase of the pilot signals received by the second device from each of the plurality of antennas compared to the pilot signals received by the second device from a selected antenna.

19. The device of claim 16 wherein the device is a base station.

20. A device comprising an antenna and processing means; the device being configured to:
a. receive pilot signals, transmitted by multiple antennas on a second device, at the antenna;
b. transmit pilot signals from the antenna;
c. transmit information relating to the amplitude and/or phase of the pilot signals transmitted from each antenna on the second device to the second device.

21. The device of claim 20 wherein the device is further arranged to calculate a relative value of the pilot signals received by the device from each antenna on the second device compared to the pilot signals received by the device from a selected antenna on the second device, and the step of transmitting information relating to the amplitude and/or phase of the pilot signals comprises transmitting the relative value to the second device.

22. The device of claim 20 wherein the device is a mobile terminal.
